(19) United States
(12) Patent Application Publication
(10) Pub. No.: US 2016/0009977 A1
(43) Pub. Date: Jan. 14, 2016

(54) DELAYED ENHANCEMENT OR BREAKING OF VISCOSITY FOR VISCOELASTIC SURFACTANT CONTAINING WELLBORE FLUIDS

(71) Applicant: M-I L.L.C., Houston, TX (US)

(72) Inventor: Shaohua LU, Katy, TX (US)

(21) Appl. No.: 14/409,885

(22) PCT Filed: Jun. 21, 2012
(86) PCT No.: PCT/US2012/043464

§ 371 Date: Jul. 14, 2015

(51) Int. Cl. C09K 8/035; E21B 43/16; C09K 8/76; C09K 8/60; C09K 8/52

(52) U.S. Cl. CPC C09K 8/035; C09K 8/602; C09K 8/52; C09K 8/76; E21B 43/16; C09K 2208/30

(57) ABSTRACT

A wellbore fluid is provided having controllable viscosity, which includes a brine having a monovalent salt and/or a polyvalent salt; an encapsulated monovalent salt and/or an encapsulated polyvalent salt; and a viscoelastic surfactant, where the wellbore fluid contains at least one monovalent salt and at least one polyvalent salt in the form of a brine and/or an encapsulated salt.

### TECHNICAL FIELD

The present disclosure relates generally to viscoelastic surfactants used in fracturing, gravel packing, acidizing, fluid loss control and reservoir drilling fluids used in conjunction with an encapsulated salt.

### BACKGROUND

During the drilling of a wellbore, various fluids are often used in the well for a variety of functions. The fluids may be circulated through a drill pipe and drill bit into the wellbore, and then may subsequently flow upward through wellbore to the surface. During this circulation, a wellbore fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

Another wellbore fluid used following the drilling operation is a completion fluid. Completion fluids broadly refer any fluid pumped down a well after drilling operations have been completed, including fluids introduced during acidizing, perforating, fracturing, workover operations, etc. A drill-in fluid is a specific type of wellbore fluid that is designed to drill and complete the reservoir section of a well in an open hole, i.e., the “producing” part of the formation. Such fluids are designed to balance the needs of the reservoir with drilling and completion processes. In particular, it is desirable to protect the formation from damage and fluid loss, and not impede future production. Most drill-in fluids contain several solid materials including viscosifiers, drill solids, additives used as bridging agents to prevent lost circulation, proppants, and barite weighting materials to control pressure formation.

A further application for wellbore fluids include annular fluids or packer fluids which are pumped into an annular opening between a casing and a wellbore wall or between adjacent, concentric strings of pipe extending into a wellbore. In the completion of oil and gas wells, it is currently the practice to place aqueous or non-aqueous hydrocarbon based fluids, known as packer fluids, into a casing annulus above a packer, specifically where the packer has been set to isolate production fluid from the casing annulus. Packer fluids, introduced into the casing annulus, fill the annular column to surface. Packer fluids are used to provide both pressure stability and thermal protection to the casing annulus of production oil and gas wells as well as in injection wells. The main function of a packer fluid related to pressure stabilization is to provide hydrostatic pressure in order to equalize pressure relative to the formation, to lower pressures across sealing elements or packers; or to limit differential pressure acting on the wellbore, casing and production tubing to prevent collapse of the wellbore.

Wellbore fluid compositions are known to be flowable systems that are generally thickened to a limited extent. In many cases, wellbore fluids include thickening agents, such as polymers or viscoelastic surfactants, which serve to control the viscosity of the fluids. To obtain the fluid characteristics to meet these challenges, the fluid may be easy to pump so only a small amount of pressure is required to force it through restrictions in the circulating fluid system, such as bit nozzles, down-hole tools, or narrow wellbore annuli. In other words, the fluid may have the lowest possible viscosity under high shear conditions. Conversely, in zones of the well where the area for fluid flow is large and the velocity of the fluid is slow or where there are low shear conditions, the viscosity of the fluid may be great enough in order to suspend and transport the drilled cuttings. The need for a sufficient viscosity also applies to the periods when the fluid is left static in the hole, where both cuttings and weighting materials need to be kept suspended to prevent settlement.

Viscoelastic surfactants are commonly used as thickening agents. Viscoelastic surfactants are relatively small molecules where each molecule may be less than 500 grams per mole (i.e., molecular weight less than 500). The individual molecules of surfactant begin to associate to form rod-like or spiraling-cylinder-like micelles or other micellar structures. These micelle structures are always in an equilibrium state of breaking and reforming. As dynamic structures, micelles are readily destroyed by shear, presence of hydrocarbons or increased temperature. While these features are desirable especially in a hydrocarbon-bearing formation, there is minimal control over the conditions under which micelle breakup occurs. Therefore, under conditions of exposure to oil, high temperature, high shear, or other “stress conditions”, the viscoelastic surfactants rapidly return to their original small independent spherical micellar state. When the viscoelastic micelles are broken down to this small independent spherical micellar state, the desired viscous nature of the well fluid is lost. In some cases the loss is temporary, in others the loss may be more permanent.

The control of viscosity of viscoelastic fluids is highly desired as different viscosity ranges may be more beneficial during different stages of the applications. For instance, in fracturing, while high fluid viscosity is needed for proppant suspension and diverting, often it is necessary to reduce the viscosity of the viscoelastic fluid prior to production of hydrocarbons by “breaking” or disrupting the micelles of the viscoelastic surfactant. In other words, an ideal viscoelastic fluid should have high viscosity in the first stage and low viscosity (or totally broken) in the second stage.

Accordingly, there exists a continuing need to improve viscosification of wellbore fluids using viscoelastic surfactant compositions.

### SUMMARY

In one aspect, embodiments disclosed herein relate to a wellbore fluid having controllable viscosity, which includes a brine having a monovalent salt and/or a polyvalent salt; an encapsulated monovalent salt and/or an encapsulated polyvalent salt; and a viscoelastic surfactant, where the wellbore fluid contains at least one monovalent salt and at least one polyvalent salt in the form of a brine and/or an encapsulated salt.

In another aspect, embodiments disclosed herein relate to a method for injecting a wellbore fluid having controllable viscosity into a wellbore, including: injecting a wellbore fluid into the wellbore, the wellbore fluid including: a brine comprising a monovalent salt and/or a polyvalent salt, an encapsulated monovalent salt and/or an encapsulated polyvalent salt, and at least one viscoelastic surfactant, where the wellbore fluid contains at least one monovalent salt and at least one polyvalent salt in the form of a brine and/or an encapsulated salt; and allowing the encapsulated monovalent salt and/or an encapsulated polyvalent salt to release a percentage of the total available salt from the encapsulated salt, where the percent of the total available salt is an amount of salt effective to cause a change in the viscosity of the wellbore fluid.

Other aspects and advantages of the invention will be apparent from the following description and the appended claims.

### BRIEF DESCRIPTION OF DRAWINGS

FIG. 1 is a schematic representation of various packing parameters of viscoelastic surfactants in accordance with embodiments disclosed herein.

FIGS. 2-10 present graphical data related to the control of VES-containing wellbore fluids using encapsulated salts.

### DETAILED DESCRIPTION

Embodiments disclosed herein relate to wellbore fluids having viscoelastic surfactants therein (and methods of using such wellbore fluids) for various well operations. Particularly, embodiments of the present disclosure relate to viscoelastic wellbore fluids formulated with a monovalent salt and an encapsulated salt for the controlled release of polyvalent salts, including polyvalent cations, for example, creating a delayed enhancement or breaking of the measured viscosity of the wellbore fluid. Polyvalent salts of this disclosure are salts having valence numbers greater than one and able to bind multiple ligands or anions. Such salts include divalent cations or anions, trivalent cations or anions, tetravalent cations or anions, etc.

In another embodiment, encapsulated polyvalent salts disposed within a wellbore fluid containing a viscoelastic surfactant and a monovalent salt may act to both induce an increase in viscosity and, upon reaching a threshold concentration, act as a breaker which disrupts the formed gel, resulting in a decrease of viscosity. The viscoelastic wellbore fluids formulated with a delayed salt source may be used as, but not limited to, completion fluids, drill-in fluids, packer fluids, displacement fluids, fracturing fluids, or carrier fluids for gravel packing.

Viscoelastic Surfactants

The term “viscoelastic” refers to those viscous fluids having elastic properties, i.e., the liquid at least partially returns to its original form when an applied stress is released. As mentioned above, the wellbore fluids of the present disclosure may be used in applications where viscoelastic surfactant-based (VES) fluids are placed in the wellbore for a variety of applications discussed herein. In accordance with the present disclosure, an encapsulated mono- or poly-valent salt may be used in conjunction with a viscoelastic surfactant to result in an unexpected ability to both increase the wellbore fluid's viscosity and, at threshold concentrations, initiate a reduction in the viscosity of the wellbore fluid.

Any type or combination of viscoelastic materials that can form micelles (spherulite, cylindrical, bilayer, or inverted micelle) in the presence of counter ions in aqueous solutions, thereby imparting viscosity to the fluid may be used in keeping with the principles of this disclosure. In a particular embodiment, cylindrical micelles may be formed and may have a viscosity that closely resembles that of a polymer solution, which may be due to entanglement or interaction between micelle structures. However, in accordance with the present disclosure, the inventors have found a mechanism which is believed to affect the micelle structures formed and results in the most desirable viscosity increase without simply adding greater quantities of the viscoelastic surfactant.

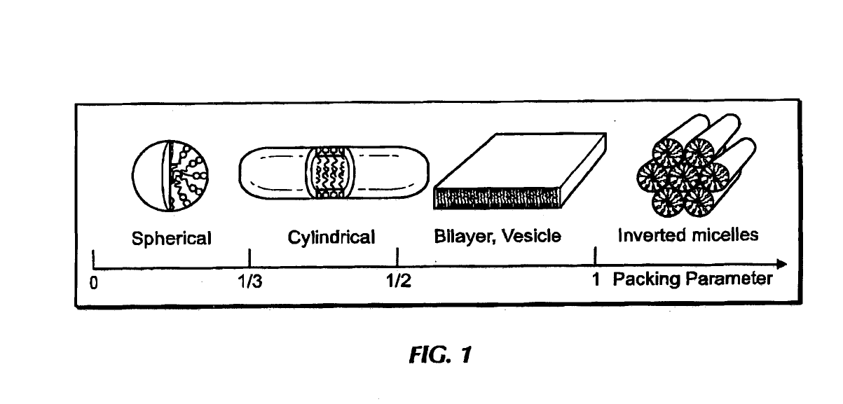

The high viscoelasticity of the VES-containing fluids of the present disclosure may be attributed to worm-like or thread-like micelles that undergo entanglement and consequently form networks. Because of the formation and constant rearrangement of micellar networks, VES-containing fluids are sometimes considered “living polymer” systems. Rheological properties are determined by the micellar structure, which may be related to the geometry of the surfactant molecules as represented by the packing parameter and counter ions. A representative micellar structure is shown in FIG. 1, depicting a hydrophilic group at the top of the figure with a hydrocarbon chain extending therefrom. Based on the micellar structure, the packing parameter, P, may be defined as P=V/al, where V is the volume of the hydrocarbon chain, a is the optimal cross-sectional area of the hydrophilic group (sometimes referred to as headgroup) and l is the length of the hydrocarbon chain (sometimes referred to the tail). Without being bound to a particular theory, to achieve high viscosity, the surfactant molecules forming worm-like micelles should possess a low curvature that promotes one-dimensional growth or such effect may be achieved through the incorporation of a mixture of monvalent and polyvalent cations.

The packing parameter may be used to estimate the aggregation structure (spherical, cylindrical, bilayer invert micelles) of the micelles. In turn, the aggregation structure can determine the viscosity or rheological property of the fluid. It is believed that cylindrical or worm-like micelles that undergo one dimensional growth may have the highest viscosity as compared to the other micellar structures. Therefore, various embodiments of the present disclosure seek to optimize the micellar structure to achieve maximum viscosity. As seen in FIG. 1, those surfactants that form cylindrical micelles may have a packing parameter around 0.5.

Common VES surfactants generally provide a constant v/l ratio, independent of tail length, of approximately 21 Å². Thus, assuming the chain length has no effect on the aggregation structure, the packing parameter and therefore viscosity is determined by the area of the headgroups. The area of headgroups may be influenced directly by the interaction between adjunct headgroups and other molecules (water and ions) in the wellbore fluid. Without being bound to a particular theory, the inventor of the present application believes that the presence of ions in solution affect the electrostatic force between charged headgroups, affecting the area of the headgroups and thus the packing parameter. Thus, for a given surfactant, having a given initial packing parameter, a mixture of monovalent and polyvalent cations (or anions, depending on the charge of the headgroup) may be used to adjust the packing parameter of the viscoelastic surfactant closer to the optimal 0.5 value. Specifically, the inventor of the present disclosure have found that a brine having a majority of its salts formed from monvalent salts and a minority (but necessarily present) amount of its salts formed from polyvalent salts will unexpectedly affect the viscosity of the fluid in a positive manner.

Again, without being bound to a particular theory unless expressly stated in the claims, it is believed that the increase in viscosity is a result of this combination of monovalent salts and polyvalent salts' affect on the packing parameter. For example, for a zwitterionic surfactant having both positive and negative charges at the headgroup and a relatively high initial packing parameter, the polyvalent cations may increase the area of the headgroup and thus decrease the packing parameter. However, depending on the type (charge of the headgroup) and the native packing parameter of the surfactant, the type of ions incorporated may be altered depending on how the initial packing parameter should be adjusted to approach 0.5.

To provide the ionic strength for the desired micelle formation, the VES-containing fluid systems of the present disclosure may include at least two water-soluble salts, at least one monvalent salt and at least one polyvalent salt. Adding such salts to the wellbore fluid may help promote micelle formation for the viscosification of the fluid. Suitable water-soluble salts may comprise lithium, ammonium, sodium, potassium, cesium, titanium, molybdenum, lanthanum, zirconium, magnesium, calcium, or zinc cations, and chloride, bromide, iodide, nitrate, borate, acetate, cyanate, or thiocyanate anions. Examples of suitable water-soluble salts that comprise the above-listed anions and cations include, but are not limited to, ammonium chloride, sodium molybdate, lanthanum chloride, lithium bromide, lithium chloride, lithium nitrate, calcium bromide, calcium chloride, calcium nitrate, sodium bromide, sodium chloride, sodium nitrate, potassium chloride, potassium bromide, potassium nitrate, cesium nitrate, cesium chloride, cesium bromide, magnesium chloride, magnesium bromide, zinc chloride, and zinc bromide. The density of the brine may range from a lower limit of greater than 3 ppg, 5 ppg, 7 ppg, 9 ppg to an upper limit of less than 11 ppg, 13 ppg, 15 ppg, 17 ppg, 19 ppg, 20 ppg, where the density may range from any lower limit to any upper limit. As discussed in the present application, an amount of one or more mono-, di-, or poly-valent salts may be provided initially to a fluid in an encapsulated form.

Combinations of monovalent and polyvalent brines mixed with a VES may result in an unexpected viscosity increase. The achievable viscosity may be greater than either viscosity achievable with the monovalent brines or polyvalent brines mixed with the VES-containing fluid alone. An optimum mixing ratio may be determined based upon the packing parameter of the VES-containing fluid. Shear thinning and high shear stress, or tau zero, properties may be achieved when providing the mixture of monovalent and polyvalent brines providing advantages in certain wellbore fluid applications. Further, by providing at least a portion of the polyvalent salt in an encapsulated form, the effect of the polyvalent salt on viscosity may be a delayed increase or decrease in viscosity. It is also within the scope of this disclosure that a portion of the monovalent salt may be encapsulated and provided to a VES-containing wellbore fluid, which may also include a polyvalent salt or a ratio of mono- and/or polyvalent salt, to effect an increase or decrease in the observed viscosity of the wellbore fluid.

The presence of ions can suppress the electrostatic force between charged head groups and thus reduces the area of head group. However, VES surfactants can have an initial packing parameter greater than the optimal value for the formation of cylindrical micelles, 0.5, even without salt, as shown in Table 1 below. It is believed that the combination of polyvalent and monovalent brines may lead to an optimized packing of the VES surfactants head groups, similar to the packing of two different sizes of balls being better than the packing of single size balls. It may be theorized that the further the initial packing parameter of the VES is away from the optimal value, 0.5, the more polyvalent ions may be present to effect an increase in viscosity.

TABLE 1
Packing parameters and optimal ratios for selected surfactants, in
accordance with an embodiment of the present disclosure.

| | Viscoelastic Surfactant | | |
|---|---|---|---|
| | VES-A | VES-B | VES-C |
| Area of hydrophilic | 12 | 28 | 28 |
| group, Å² | | | |
| V/a, Å² | 21 | 21 | 21 |
| Initial packing parameter | 1.7 | 0.75 | 0.75 |
| Optimal | 3~40% | 0.1~2% | 0.1~2% |
| polyvalent/monovalent | | | |
| molar ratio for viscosity | | | |
| increase | | | |

From Table 1, it may be theorized that for a VES having an initial packing parameter up to 0.8, the optimal polyvalent/monovalent ratio may be up to 2%, for 0.8 to 1.5 the ratio may be 1-10% and for 1.5 and higher the ratio may be 3% or more. Such ratios may be optimal for viscosity increase. Ratios below and above such ranges may be optimal when low viscosity is desired, such as during emplacement and breaking of a VES-containing fluid.

Thus, for any viscoelastic surfactant having an initial packing parameter, the optimal polyvalent/monovalent ratio for high or low viscosity may be estimated by mixing the surfactant in a monovalent brine and slowly adding a polyvalent salt therein to observe an increase in the tau zero and/or gel strength of the fluid. A starting ratio of polyvalent to monovalent brine may also be surmised based on the initial packing parameter compared to the packing parameters and optimal brine ratios shown in Table 1.

In one embodiment, the viscosity of the wellbore fluid may be controlled by increasing the amount of a polyvalent salt dissolved in the fluid, such as by dissolving an encapsulating material in which the polyvalent salt is provided into the fluid. In a particular embodiment, a wellbore fluid may include halide or carboxylate salts of mono- and polyvalent cations of metals, such as cesium, potassium, calcium, zinc, titanium, zirconium, lanthanum and/or sodium. Further, when greater temperature stability is desired, one skilled in the art would appreciate that it may be desirable to include water miscible solvents such as various glycols to improve the thermal stability of the fluid system.

In another embodiment, the viscosity of the fluid may increase until the ratio of the free polyvalent salts and monovalent salts exceeds a predetermined value, for example ratios such as those defined in Table 1, wherein the excess of polyvalent cations destabilizes the cylindrical micellar network, decreasing the observed viscosity of the viscoelastic fluid.

The wellbore fluids of the present disclosure may thus have several components: a monovalent salt, an encapsulated polyvalent salt, and a viscoelastic surfactant. The monovalent salt may be dissolved in a base fluid, either aqueous or non-aqueous. Inventors of the present disclosure have found that wellbore fluids including monovalent and polyvalent salts increase the viscosity of the fluid without large amounts of the polyvalent salt in the viscoelastic surfactant being used, and that polyvalent salts may be provided in an encapsulated form to delay the presence of the polyvalent salts, leading to an increase, decrease, or both increase and then decrease the viscosity of the wellbore fluid. Other embodiments may use a polyvalent salt dissolved in the fluid and an encapsulated monovalent salt. Further, it should be appreciated that for whichever salt is encapsulated some amount of the same type of salt may be pre-dissolved in the VES-containing fluid.

Further, in a particular embodiment, the amounts of monovalent brine and polyvalent brine may be optimized to increase and/or the viscosity by stabilizing/destabilizing the viscoelastic surfactants. It has been observed that upon the addition of the polyvalent brine, the viscosity change may be near instantaneous.

The molar ratio of polyvalent to monovalent brines may be estimated based upon the packing parameter as shown above in Table 1. The farther away the packing parameter is from 0.5, the higher the molar ratio of polyvalent to monovalent brines for increasing the viscosity (i.e., more polyvalent ions may be present to affect an increase in viscosity). For example, the molar ratio of polyvalent to monovalent salt may range from about 0.1% to about 40%, from about 0.1% to about 2%, from about 5% to about 25%, from about 4% to about 18%, or from about 0.2% to about 3%, depending on the particular surfactant (and its packing parameter) selected.

The inventor of the present disclosure has also found that a maximum viscosity is obtained at the optimal ratio of polyvalent brine to monovalent brine. It is theorized that at the optimum ratio of polyvalent brine to monovalent brine, the packing or assembly of the VES surfactants reaches an optimum structure, which leads to growth and entanglement of wormlike micelles and thus generates high viscosity. In addition, the inventor of the present disclosure has found that, by increasing the ratio of polyvalent brine to monovalent brine over the optimum may be used advantageously to break the viscosity of the VES-containing fluid, reducing tau zero and the overall gel strength. Thus, if a reduction in viscosity is desired, such as when breaking a gravel pack carrier fluid, an additional quantity of monovalent or polyvalent salts may cause a decrease in the fluid viscosity. In accordance with embodiments of the present disclosure, one or more of such viscosity changes may be triggered by dissolution or unencapsulation of the previously encapsulated salt.

The viscoelastic surfactants used in the wellbore fluids of the present disclosure may include cationic, nonionic, anionic, amphoteric, and zwitterionic viscoelastic surfactant systems. In general, particularly suitable zwitterionic surfactants have the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻

in which R is an alkyl group that contains from about 11 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0, and (a+b) is from 2 to 10 if m is 0; a′ and b′ are each 1 or 2 when m′ is not 0, and (a′+b′) is from 1 to 5 if m is 0; (m+m′) is from 0 to 14; and CH₂CH₂O may also be OCH₂CH₂.

Zwitterionic surfactants may include betaines. Two suitable examples of betaines are BET-O and BET-E. The surfactant in BET-O-30 is shown below; one chemical name is oleylamidopropyl betaine. It is designated BET-O-30 because as obtained from the supplier (Rhodia, Inc. Cranbury, N.J., U.S.A.) it is called Mirataine BET-O-30 because it contains an oleyl acid amide group (including a C₁₇H₃₃ alkene tail group) and contains about 30% active surfactant, the remainder being substantially water, sodium chloride, and propylene glycol. An analogous material, BET-E-40, is also available from Rhodia and contains an erucic acid amide group (including a C₂₁H₄₁ alkene tail group) and is approximately 40% active ingredient, with the remainder being substantially water, sodium chloride, and isopropanol. VES systems, in particular BET-E-40, optionally contain about 1% of a condensation product of a naphthalene sulfonic acid, for example sodium polynaphthalene sulfonate, as a rheology modifier, as described in U.S. Pat. No. 7,084,095, which is herein incorporated by reference. The surfactant in BET-E-40 is also shown below; one chemical name is erucylamidopropyl betaine. BET surfactants, and other VES are described in U.S. Pat. No. 6,258,859, which is herein incorporated by reference. According to that patent, BET surfactants make viscoelastic gels when in the presence of certain organic acids, organic acid salts, or inorganic salts; in that patent, the inorganic salts are described as being present at a weight concentration up to about 30%. Co-surfactants may be useful in extending the brine tolerance, and to increase the gel strength and to reduce the shear sensitivity of the VES-fluid, in particular for BET-O-type surfactants. An example given in U.S. Pat. No. 6,258,859 is sodium dodecylbenzene sulfonate (SDBS). Still other suitable co-surfactants for BET-O-30 are certain chelating agents such as trisodium hydroxyethylethylenediamine triacetate.

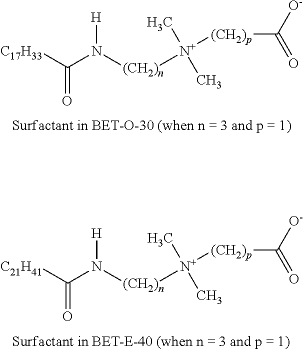

Other betaines that are suitable include those in which the alkyl side chain (tail group) contains 11-23 carbon atoms (not counting the carbonyl carbon atom) which may be branched or straight chained and which may be saturated or unsaturated, n=2-10 (and n=3-5 in a more particular embodiment), and p=1-5 (and p=1-3 in a more particular embodiment), and mixtures of these compounds.

Cationic viscoelastic surfactants may include the quaternary amine salts disclosed in U.S. Pat. Nos. 5,979,557, and 6,435,277 which are hereby incorporated by reference. Examples of suitable cationic viscoelastic surfactants include cationic surfactants having the structure:

R₁N⁺(R₂)(R₃)(R₄)X⁻

in which R₁ has from about 14 to about 26 carbon atoms and may be branched or straight chained, aromatic, saturated or unsaturated, and may contain a carbonyl, an amide, a retroamide, an imide, a urea, or an amine; R₂, R₃, and R₄ are each independently hydrogen or a C₁ to about C₆ aliphatic group which may be the same or different, branched or straight chained, saturated or unsaturated and one or more than one of which may be substituted with a group that renders the R₂, R₃, and R₄ group more hydrophilic; the R₂, R₃, and R₄ groups may be incorporated into a heterocyclic 5- or 6-member ring structure which includes the nitrogen atom; the R₂, R₃, and R₄ groups may be the same or different; R₁, R₂, R₃, and/or R₄ may contain one or more ethylene oxide and/or propylene oxide units; and X⁻ is an anion. Mixtures of such compounds are also suitable. As a further example, R₁ is from about 18 to about 22 carbon atoms and may contain a carbonyl, an amide, or an amine, and R₂, R₃, and/or R₄ are the same as one another and contain from 1 to about 3 carbon atoms.

Cationic surfactants systems having the structure R₁N⁺(R₂)(R₃)(R₄)X⁻ may optionally contain the non-ionic amine analogs having the structure R₁N(R₂)(R₃), incorporated therein. It is well known that commercially available cationic quaternary amine surfactants often contain the corresponding nonionic amines (in which R₁, R₂, and R₃ in the cationic surfactant and in the amine have the same structure). As received commercially available VES surfactant concentrate formulations, for example cationic VES surfactant formulations, may also optionally contain one or more members of the group consisting of alcohols, glycols, organic salts, chelating agents, solvents, mutual solvents, organic acids, organic acid salts, inorganic salts, oligomers, polymers, co-polymers, and mixtures of these members. They may also contain performance enhancers, such as viscosity enhancers, for example polysulfonates, for example polysulfonic acids, as described in U.S. Pat. No. 7,084,095 which is hereby incorporated by reference.

Another suitable cationic VES is erucyl bis(2-hydroxyethyl)methyl ammonium chloride, also known as (Z)-13 docosenyl-N—N-bis(2-hydroxyethyl)methyl ammonium chloride. It is commonly obtained from manufacturers as a mixture containing about 60 weight percent surfactant in a mixture of isopropanol, ethylene glycol, and water. Other suitable amine salts and quaternary amine salts include (either alone or in combination in accordance with the invention), erucyl trimethyl ammonium chloride; N-methyl-N,N-bis(2-hydroxyethyl) rapeseed ammonium chloride; oleyl methyl bis(hydroxyethyl) ammonium chloride; erucylamidopropyltrimethylamine chloride, octadecyl methyl bis(hydroxyethyl) ammonium bromide; octadecyl tris(hydroxyethyl) ammonium bromide; octadecyl dimethyl hydroxyethyl ammonium bromide; cetyl dimethyl hydroxyethyl ammonium bromide; cetyl methyl bis(hydroxyethyl) ammonium salicylate; cetyl methyl bis(hydroxyethyl) ammonium 3,4,-dichlorobenzoate; cetyl tris(hydroxyethyl) ammonium iodide; cosyl dimethyl hydroxyethyl ammonium bromide; cosyl methyl bis(hydroxyethyl) ammonium chloride; cosyl tris(hydroxyethyl) ammonium bromide; dicosyl dimethyl hydroxyethyl ammonium bromide; dicosyl methyl bis(hydroxyethyl) ammonium chloride; dicosyl tris(hydroxyethyl) ammonium bromide; hexadecyl ethyl bis(hydroxyethyl) ammonium chloride; hexadecyl isopropyl bis(hydroxyethyl) ammonium iodide; and cetylamino, N-octadecyl pyridinium chloride.

The viscoelastic surfactant system may also be based upon any suitable anionic surfactant. In some embodiments, the anionic surfactant is an alkyl sarcosinate. The alkyl sarcosinate can generally have any number of carbon atoms. Alkyl sarcosinates can have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula: R₁CON(R₂)CH₂X wherein R₁ is a hydrophobic chain having about 12 to about 24 carbon atoms, R₂ is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecentyl group, an octadecyl group, and a docosenoic group.

In other embodiments, to achieve the rheological properties desired for the fluids of the present disclosure, at least one amphoteric viscoelastic surfactant may be provided in the fluid. The term “amphoteric” refers to a compound that can act either as an acid or a base. Amphoteric viscoelastic surfactant systems may include those described in U.S. Pat. No. 6,703,352, for example amine oxides. Other viscoelastic surfactant systems include those described in U.S. Pat. Nos. 6,239,183; 6,506,710; 7,060,661; 7,303,018; and 7,510,009, for example amidoamine oxides. These six references are hereby incorporated in their entirety. Mixtures of zwitterionic surfactants and amphoteric surfactants may also be suitable.

The selection of the surfactant concentration may depend on the particular wellbore operation (packer fluid, hydraulic fracturing, spacer fluid, drill-in fluid, etc). The amount of VES (in solvent) may range from about 1 to about 12 volume percent, or from about 2 to about 10 volume percent, or from about 4 to about 8 volume percent where the amount of surfactant in the solvent generally ranges from about 30 to 50 percent. These percentages are for VES which may be provided in a solvent. However, other amounts may be used, so long as the surfactant is present in an amount sufficient to impart the desired rheological effect by the formation of micelles within the wellbore fluid. In a particular embodiment, the amount of active surfactant may be selected based on the viscosity desired for the particular application. Further, while concentrations of greater than 10% have conventionally been used to generate the increased viscosity, the use of mixed brines to bring the packing parameter closer to 0.5 and encourage formation of cylindrical micelles, resulting in a substantial increase in viscosity, may also reduce the amount of VES that is used in the fluid.

Based on this behavior, the present disclosure also relates to a method of designing an optimal range of brine mixtures to be used with viscoelastic surfactant(s) in a fluid such as a wellbore fluid. Specifically, an amount of viscoelastic surfactant may be mixed in a monovalent and/or polyvalent brine and an encapsulated salt may be added into the VES-containing brine. As the salt is released from encapsulation from passive diffusion or external triggering event, the rheological properties, including tau zero and gel strength, may exhibit a measurable change as the molar ratio of the polyvalent salt to the monovalent salt approaches or diverges from the optimal ratio for viscosity increase for the particular viscoelastic surfactant, such as the ratios outlined in Table 1, for example.

In one embodiment, an encapsulated salt added to a VES-containing brine may release a quantity of monovalent or polyvalent salt sufficient to bring the molar ratio of the polyvalent salts to monovalent salts to the optimal ratio for viscosity increase, and continue to release the monovalent or polyvalent salt until the tau zero and/or gel strength properties return to approximately that of a standard brine. Further, the amount of encapsulated salt added may be based on the packing parameter of the VES being used. For example, for a VES having a packing parameter closer to 0.5, smaller quantities of salt may be needed, whereas larger quantities may be needed as the packing parameter increases substantially.

Conventional methods can be used to prepare the wellbore fluids disclosed herein in a manner analogous to those normally used to prepare conventional water- and oil-based wellbore fluids. In one embodiment, a desired quantity of VES and a brine, as described above, are mixed together. An encapsulated salt may be added sequentially with continuous mixing either at the surface of the well or injected into the well after the VES-containing brine have been pumped down the well.

Those skilled in the art will appreciate that by a number of configurations of brines and encapsulated salts may be used in accordance with this disclosure to achieve wellbore fluids having controllable viscosity. For example, the VES-containing fluids of the present disclosure may contain a monovalent brine and an encapsulated polyvalent salt. In other embodiments, the YES-containing wellbore fluid may be a polyvalent brine and the encapsulated salt is a monovalent salt. In other embodiments, a brine containing both monovalent and polyvalent salts at a molar ratio of polyvalent salt to monovalent salt below the optimal ratio for viscosity increase, as described in Table 1 for example, and which is still pumpable, may be used to reduce the total amount of encapsulated monovalent or polyvalent salt required to achieve the optimal ratio for the desired change in viscosity.

It is also envisioned that VES-containing fluids of the present disclosure may be used as drill-in fluids. As known in the art, drill-in fluids are circulated down through a hollow drill stem and out through a drill bit attached thereto while rotating the drill stem to drill the wellbore. The drill-in fluid may be flowed back to the surface via the annular space between the drill string and the wellbore to deposit a filter cake on the walls of the wellbore and to carry drill cuttings to the surface.

In addition, the VES-containing fluids of the present disclosure may be used as completion fluids, work-over fluids, spacer fluids, and liquid plugs. For example, as completion fluids, the VES-containing fluids and encapsulated polyvalent salt may be placed in the well annulus to facilitate final operations prior to initiation of production. The VES-containing fluids of the present disclosure may be pumped through the wellbore, so that its fluid helps push other fluids through the annulus. In other embodiments, it may be pumped into the annulus above or below a packer element as a packer fluid, for example, to provide hydrostatic pressure to lower a differential pressure across the packer element and/or to provide differential pressure against a casing or formation wall to prevent well collapse. The VES-containing fluids of the present disclosure may be used to control a well should downhole hardware lose integrity, without damaging the producing formation or completion components. The brine including a viscoelastic surfactant and an encapsulated polyvalent salt may be prepared prior to the fluid being placed downhole in a single stream embodiment.

Viscoelastic surfactant containing wellbore fluids, for example those used in the oilfield, may also contain agents that dissolve minerals and compounds, for example in formations, scale, and filtercakes. Such agents may be, for example, hydrochloric acid, formic acid, acetic acid, lactic acid, glycolic acid, sulfamic acid, malic acid, citric acid, tartaric acid, maleic acid, methylsulfamic acid, chloroacetic acid, aminopolycarboxylic acids, 3-hydroxypropionic acid, polyaminopolycarboxylic acids, for example trisodium hydroxyethylethylenediamine triacetate, and salts of these acids and mixtures of these acids and/or salts. For sandstone treatment, the fluid may also contain a hydrogen fluoride source. The hydrogen fluoride source may be HF itself or may be selected from ammonium fluoride and/or ammonium bifluoride or mixtures of the two; when strong acid is present the HF source may also be one or more of polyvinylammonium fluoride, polyvinylpyridinium fluoride, pyridinium fluoride, imidazolium fluoride, sodium tetrafluoroborate, ammonium tetrafluoroborate, and salts of hexafluoroantimony. When the formation-dissolving agent is a strong acid, the fluid may contain a corrosion inhibitor. The fluid may optionally contain chelating agents for polyvalent cations, for example especially aluminum, calcium and iron (in which case the agents are often called iron sequestering agents) to prevent their precipitation. Some of the formation-dissolving agents just described are such chelating agents as well. Chelating agents are added at a concentration, for example, of about 0.5% (of active ingredient). When VES-containing fluids contain strong acids, they are may not be gelled and/or display low viscosity; when the pH increases as the acid reacts with the mineral, the system gels and the viscosity increases. Such fluids may be called viscoelastic diverting acids, or VDAs. The rheology enhancers may be used in viscoelastic surfactant fluid systems containing acids and chelating agents.

Other additives that may be included in the wellbore fluids disclosed herein include, for example, wetting agents, organophilic clays, viscosifiers, fluid loss control agents, surfactants, dispersants, interfacial tension reducers, pH buffers, mutual solvents, thinners, thinning agents, and cleaning agents. The addition of such agents should be well known to one of ordinary skill in the art of formulating wellbore fluids and muds.

In some embodiments, additives used in conjunction with VES-containing wellbore fluids may also include proppants or other particulates useful for gravel packing. Examples of suitable substrates include natural and synthetic silica sand, glass beads, quartz, ceramics, thermoplastic resin, sintered bauxite, metal oxides, and mixtures thereof. In some embodiments, the substrates may be porous.

When the VES-containing fluids of the present disclosure are used as a gravel packing carrier fluid, a liner is provided with a cross-over sub assembly to allow a slurry of particulate material and the viscous fluid to be pumped through the liner and the cross-over sub assembly into the annulus of a lower wellbore section where the particulate material settles out of the slurry. The viscous fluid may then circulate back via the cross-over sub assembly and the annulus between the liner and the wellbore wall (or casing), to the surface. In order to be able to fill the annular space with sand completely and successfully, the hydrocarbon-bearing formation should have been previously covered with a thin layer of firm and substantially impermeable filter cake formed by the reservoir drilling fluid. This thin and impermeable filter cake may prevent the gravel pack fluid from entering the formation, and may result in gravel pack failure.

After the gravel pack sand has been successfully placed, the filter cake existing between the gravel pack sand and the formation needs to be removed before the flow of hydrocarbon is initiated. Without the removal of the filter cake, plugging of the production screen by the filter cake could occur, impairing production.

Various chemicals, breakers and mechanical devices have been developed and used to destroy a filter cake that is behind the gravel pack sand. Breakers are normally pumped on a separate trip after the gravel pack sand has been set. They are not pumped during the gravel pack operation because they can create precarious conditions for the operation. For instance, the acid-based breakers can destroy the filter cake during gravel pack operation, and consequently result in high fluid loss and premature failure in the gravel pack operation.

The wellbore fluid may be placed in the well prior to the emplacement of a fluid loss pill or diverting treatment and may result from a brine solution, including at least one viscoelastic surfactant and a first brine solution including one or more water soluble monovalent cation salts, being used as a drilling fluid or component of a drilling fluid used in the well. In other embodiments, if fluid loss to the formation is detected, a monovalent brine solution (including the viscoelastic surfactant) may be injected into the well and into the area surrounding the fluid loss so that once the fluid loss pill or diverting treatment, including an encapsulated polyvalent salt, is emplaced in the well, the monovalent brine and the diverting treatment may interact to form a plug that may reduce the amount of fluid loss to the formation. A “plug” may be an obstructing mass of material. For example, if a well is originally drilled with a wellbore fluid including a viscoelastic surfactant and a monovalent brine and excessive fluid loss is encountered, then an encapsulated polyvalent salt pill may be emplaced, to form the plug. In other embodiments, the wellbore fluid including at least one viscoelastic surfactant, a first brine solution including one or more water soluble monovalent cation salts, and an encapsulated water soluble polyvalent cation salt may be pre-mixed and injected into the well. The wellbore fluid may also be used as a fluid loss pill or diverting treatment. Similarly, a polyvalent brine containing the viscoelastic surfactant may be used in conjunction with an encapsulated monovalent salt as a fluid loss pill or diverting treatment, or the brine may contain a ratio of monovalent and polyvalent salts and the fluid loss pill or diverting treatment is one of an encapsulated monovalent salt or an encapsulated polyvalent salt.

The fluid loss pill or diverting treatment may be injected into a work string, flow to bottom of the wellbore, and then out of the work string and into the annulus between the work string and the casing or wellbore. This batch of treatment is typically referred to as a “pill.” The pill may be pushed by injection of other completion fluids behind the pill to a position within the wellbore which is immediately above a portion of the formation where fluid loss is suspected. Injection of fluids into the wellbore is then stopped, and fluid loss will then move the pill toward the fluid loss location. Positioning the pill in a manner such as this is often referred to as “spotting” the pill. The fluid loss pill or diverting treatment may then react with the brine to form a plug near the wellbore surface, to reduce fluid flow into the formation.

The fluid loss pill or diverting treatment may be selectively emplaced in the wellbore, for example, by spotting the pill through a coil tube or by bullheading. A downhole anemometer or similar tool may be used to detect fluid flows downhole that indicate where fluid may be lost to the formation. The relative location of the fluid loss may be determined such as through the use of radioactive tags present along the pipe string. Various methods of emplacing a pill known in the art are discussed, for example, in U.S. Pat. Nos. 4,662,448, 6,325,149, 6,367,548, 6,790,812, 6,763,888, which are herein incorporated by reference in their entirety.

In other embodiments, the wellbore fluid may be used as an insulating medium such as a packer fluid to insulate the well tubing or reduce convection currents within an annulus of a wellbore string. For example, a wellbore fluid that includes a VES-containing brine may be pumped into the annulus of a wellbore string and an amount of encapsulated salt effective to increase the viscosity of the wellbore fluid may be simultaneously or subsequently pumped down. The wellbore fluid may be added to an annuli or riser piping and maintained in contact with piping to at least partially immobilize the fluid. The wellbore fluid may therein serve as a packer providing insulation from outside conditions, such as cold water, permafrost, or high temperature formations.

Encapsulation Materials

In an embodiment, monovalent or polyvalent salts may be encapsulated to control their dissolution into the surrounding solution. For example, salts may be encapsulated in a semi-porous coating that allows the surrounding solution to diffuse in, solubilizing and releasing the corresponding salt ions at a controlled rate.

In another embodiment, the viscosity of the wellbore fluid may be modified by the addition of one or more salts encapsulated in materials having differing release profiles. The viscosity of the fluid may then be controlled by adding a first encapsulated monovalent or polyvalent salt that releases an amount of the salt at a first rate or time point, along with a second encapsulated monovalent or polyvalent salt that releases an amount of the salt at a slower rate or at a later time point. Using this approach, the encapsulated salt having the shortest release profile may release an amount of a monovalent or polyvalent salt first, causing a first change in the viscosity of the VES-containing fluid, followed by the release of a second amount of the monovalent or polyvalent salt from the encapsulated salt having the longer release profile, causing a second change in viscosity. For example, a monovalent brine may contain a polyvalent salt encapsulated in two different encapsulants with distinct release profiles, such that, at a first time point, an amount of polyvalent salt is released from the encapsulant having the shorter release profile, causing an increase in viscosity, and at a later time point a second amount of polyvalent salt is released, causing a decrease in overall viscosity of the wellbore fluid. Conversely, the strategy may be employed in which the viscosity of a polyvalent brine may be controlled through the addition of a monovalent salt encapsulated in two or more encapsulants having different release profiles.

In yet another possible variation, a wellbore fluid may contain both an encapsulated polyvalent salt and an encapsulated monovalent salt, each having a differing release profile, such that the release of the polyvalent salt at first time point causes a first viscosity change, and the release of the monovalent salt at a later time point cause a second viscosity change, or vice versa.

In another embodiment, the monovalent salt or polyvalent salt may be contained in an encapsulant particle having a layered structure. For example, a first amount of a salt may be contained within an encapsulant layer having a first release profile, and be disposed on top of another encapsulant layer or core containing a second amount of salt contained within an encapsulant having a second release profile.

In yet another embodiment, salts may be encapsulated in a coating that releases the salts in response to an external stimulus or triggering event, which may include temperature, pH, enzymatic degradation, oxidants, solvents, or physically disrupted, such as by grinding the salt-containing particles. It is also envisioned that encapsulants susceptible to triggered release may also be used in conjunction with passive diffusion encapsulants, and combined with any of the strategies disclosed above.

The encapsulation material may be a heat-activated material that remains intact prior to exposure to elevated temperatures, such as those present in a downhole environment, and upon heating, slowly melt and release the molecules or ions contained within. In some embodiments, the coating may melt at a temperature greater than 125° F. (52° C.). Examples of such materials are vegetable fat, gelatin, and vegetable gums, and hydrogenated vegetable oil. Other coatings may include materials selected from lipid materials such as, but not limited to, mono-, di-, and tri-glycerides, waxes, and organic and esters derived from animals, vegetables, minerals, and modifications. Examples include glyceryl triestearates such as soybean oil, cottonseed oil, canola oil, carnuba wax, beeswax, bran wax, tallow, and palm kernel oil. Heat-activated materials may also include those disclosed in U.S. Pat. No. 6,312,741, which is incorporated herein by reference in its entirety.

In a particular embodiment, the encapsulating material may include enteric polymers, which are defined for the purposes of the present disclosure, as polymers whose solubility characteristics are pH dependent. Here, this means that salt release is promoted by a change from conditions of a first predetermined pH value to a second predetermined pH condition.

Enteric polymers are commonly used in the pharmaceutical industry for the controlled release of drugs and other pharmaceutical agents over time. The use of enteric polymers allows for the controlled release of the monovalent or polyvalent salt under predetermined conditions of pH, or a combination of pH and temperature. For example, the Glascol family of polymers are acrylic based polymers (available form Ciba Specialty Chemicals) are considered suitable enteric polymers for the present disclosure because the solubility depends upon the pH of the solution. In an illustrative embodiment of the present disclosure, an enteric polymer may be selected as an encapsulating material that is substantially insoluble at pH values greater than about 7.5 and that is more soluble under conditions of decreasing pH.

Encapsulating materials may also include enzymatically degradable polymers and polysaccharides such as galactomannan gums, glucans, guars, derivatized guars, starch, derivatized starch, hydroxyethyl cellulose, carboxymethyl cellulose, xanthan, cellulose, and cellulose derivatives. Enzymatically degradable polymers may include glycosidic linkages that are susceptible to degradation by natural polymer degrading enzymes, which may be selected from, for example, carbohydrases, amylases, pullulanases, and cellulases. In other embodiments, the enzyme may be selected from endo-amylase, exo-amylase, isoamylase, glucosidase, amylo-glucosidase, malto-hydrolase, maltosidase, isomalto-hydrolase or malto-hexaosidase. One skilled in the art would appreciate that selection of an enzyme may depend on various factors such as the type of polymeric additive used in the wellbore fluid being degraded, the temperature of the wellbore, and the pH of wellbore fluid

In yet another embodiment, release of the encapsulated monovalent and/or polyvalent salt may be triggered by the presence of an oxidant. By way of example, oxidants may include peroxides (including peroxide adducts), other compounds including a peroxy bond such as persulphates, perborates, percarbonates, perphosphates, and persilicates, and other oxidizers such as hypochlorites. In a particular embodiment, a peroxide, such as magnesium peroxide, may be used to degrade encapsulating materials. Additional peroxides that may be used include those discussed in U.S. Pat. No. 6,861,394, which is assigned to the present assignee and herein incorporated by reference in its entirety.

While a number of encapsulating compositions and release mechanisms have been discussed, many methods of encapsulating and releasing monovalent and polyvalent salts may alternatively be used without departing from the scope of the present disclosure.

As discussed above, by controlling the release of monovalent or polyvalent salts, the viscosity of VES-containing fluids can be enhanced or reduced in a controlled manner. Additionally, by controlling the concentration of the monovalent or polyvalent salts, the viscosity of the wellbore fluid may be tuned, such that, the viscosity may initially increase and, upon reaching a threshold concentration, decreasing or breaking the viscosity. Further, by varying the properties of the coating, as well as the temperature and shear conditions within the well, the release of the salts into the system may be tailored based on the desired speed and magnitude of viscosity increase of the VES-containing fluids.

It is in accordance with the teachings of the present disclosure that the delay time for the viscosity enhancement and/or reduction may be tuned to be from hours to days, which may match the operation time windows in a number of applications. By optimizing the types and concentrations of the VES-containing brine and the encapsulated salts, the system may be designed to have optimal performance for the selected operation.

In an embodiment, VES-containing fluids of the present disclosure may reach a peak viscosity after a time period ranging from 4-8 hours. In another embodiment, the viscosity may reach a peak value after a time period of 2-18 hours. In yet another embodiment, the viscosity may reach a peak value after a time period of 1-32 hours.

In another embodiment, the VES-containing fluids of the present disclosure may decrease to a minimum viscosity over a period of time ranging from 1-2 hours. In another embodiment, the viscosity may reach a minimum value over a time period ranging from 1-8 hours. In yet another embodiment, the viscosity may reach a minimum value over a time period ranging from 1 to 24 hours.

In yet another embodiment, VES-containing fluids of the present disclosure may reach a peak viscosity after a time period ranging from 1-6 hours and then return to an initial viscosity value after a time period of 2-8 hours relative to the starting time. In some embodiments, the viscosity may reach a peak value after a time period ranging from 1-8 hours and then return to an initial value after a time period of 6-12 hours relative to the starting time. In yet another embodiment, the viscosity may reach a peak value after a time period ranging from 1-12 hours and then return to an initial value after a time period of 8-48 hours relative to the starting time.

The VES-containing fluid and salt systems presented herein may be used advantageously in fracturing operations. As an illustrative example, the VES-containing fluid may be mixed with a monovalent salt brine and an encapsulated polyvalent salt may be added prior to pumping the fluid downhole. The fluid may have low viscosity while pumping to minimize pumping pressure, and upon reaching the formation, the delayed release of salt may enhance the viscosity, especially the low shear rate viscosity, of the fluid, diverting the fluid to better fracture the formation and deliver materials, such as proppants, into the fractures. After fracturing, the continuous release of polyvalent salts may break the micellar structure, leading to a viscosity drop that enhances production. In other embodiments, it is envisioned that the VES-containing fluid may be mixed with a polyvalent salt brine and an encapsulated monovalent salt prior to pumping the fluid downhole.

The VES-containing fluid and salt systems presented herein may be used advantageously in fluid loss control, wherein the VES-containing fluid may be mixed with encapsulated monovalent or polyvalent salt and then pumped downhole to the fluid loss zone. Upon reaching the fluid loss zone the release of the encapsulated salt may cause the VES-containing fluids to increase in viscosity, reducing the movement of fluids into or from the formation. The coating on the encapsulated salt may be selected such that, after a desired period of time, the released polyvalent ions may act as an internal breaker, aiding removal of the YES-containing fluid during completions operations.

### EXAMPLES

### Example 1

### Delayed Viscosity Enhancement and Breaking

In order to demonstrate the delayed enhancement and breaking of the viscosity of a VES upon the addition of an encapsulated polyvalent salt, a sample of was prepared containing 90% by volume of a 12.5 ppg NaBr brine and 10% by volume of VES-A, an oleylamidopropyl betaine viscoelastic surfactant. After the brine and VES were well mixed, 20 ppb of encapsulated CaCl₂ (80% active), available from Balchem (New Hampton, N.Y.) was added to the fluid. The encapsulated salt particulates were well dispersed and suspended in the fluids. Sample were made and maintained at 120° F.

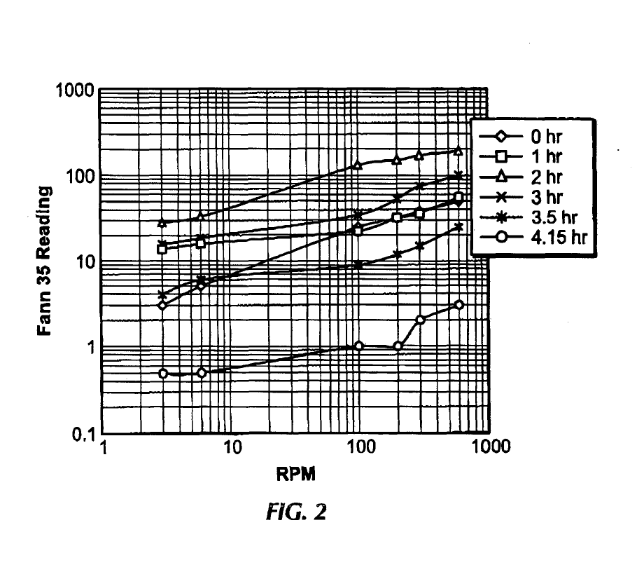

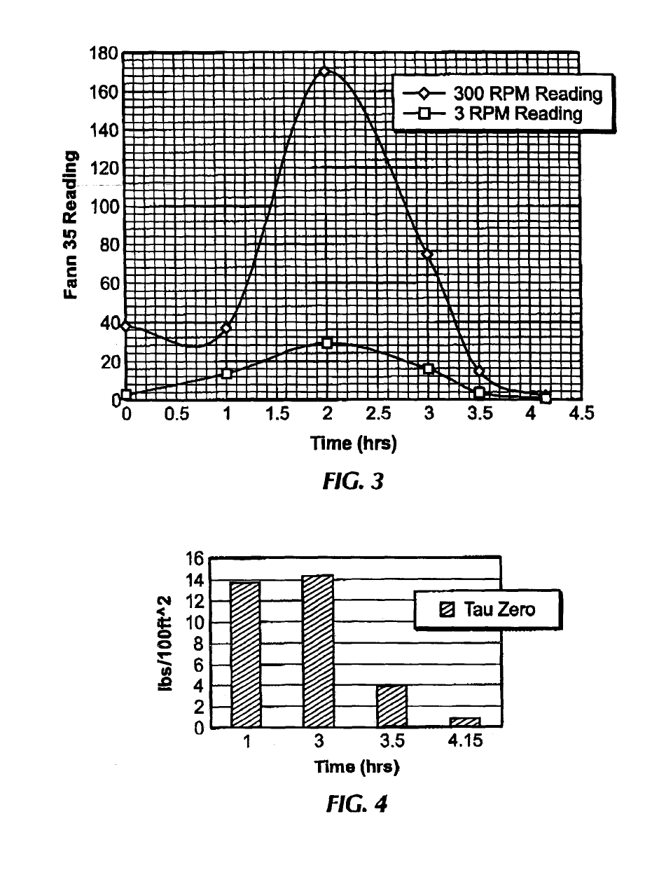

Rheological profiles were recorded using a Fann 35 viscometer at 120° F. and repeated several times. Between each measurement, the fluid was kept at 120° F. As illustrated in FIG. 2, the viscosity increases and reaches a maximum in 2 hours and then undergoes dramatic decrease. Over 4 hours, the magnitude of the viscosity reduced to essentially that of the base brine. With particular reference to FIG. 3, which shows the 300 rpm readings and 3 rpm readings are plotted as a function of time, the time dependent increase and decrease of the viscosity over 4 hours is readily apparent. In addition, the rheological curves of the sample show different characteristics over time, exhibiting characteristics of a Newtonian fluid at the start of the experiment, followed by a transition to a Herschel-Bulkley type fluid after 1 hour. Tau zero for the sample is plotted as a function of time in FIG. 4.

### Example 2

### Delayed Viscosity Enhancement

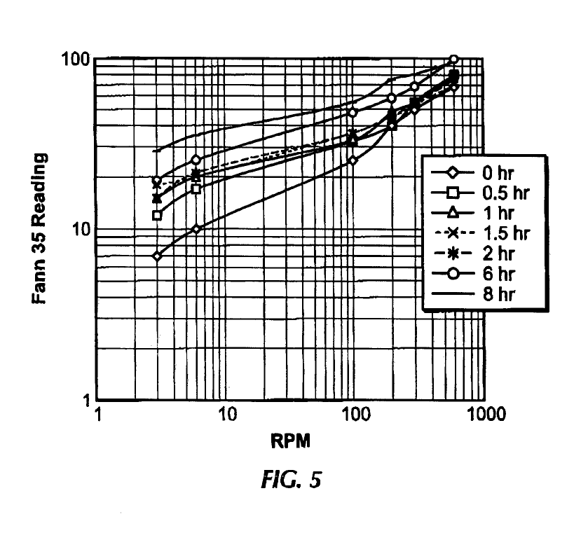

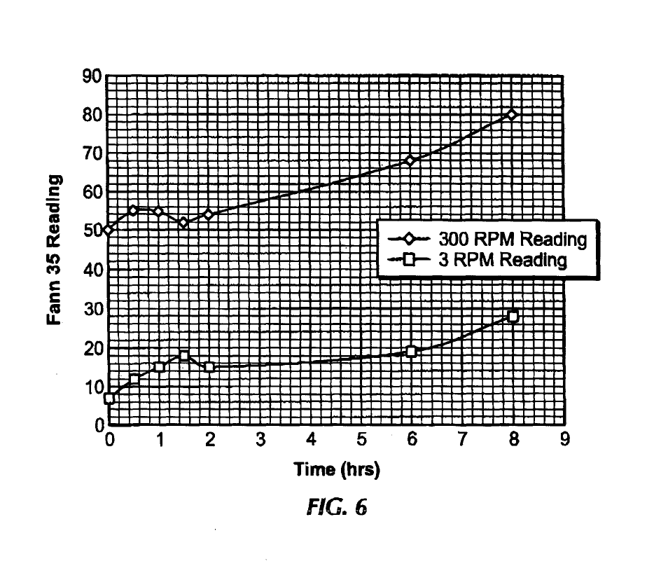

A sample wellbore fluid formulation containing a delayed viscosity enhancer was prepared from a sample containing 90% by volume of a 10 ppg NaCl brine and 10% by volume of VES-B, which was mixed and then 8 ppb of encapsulated 70% active CaCl₂, available from Balchem (New Hampton, N.Y.), was added to the sample. The 70% active CaCl₂ possesses a slower release profile, such that, the viscosity of the fluid increases steadily during the 8 hour test period, as shown in FIGS. 5 and 6.

In this example, the encapsulated CaCl₂ does not behave as a breaker, as the fluid contains 7 ppb of CaCl₂. When CaCl₂ is fully released to the solution, the molar ratio between divalent calcium ion and monovalent sodium is still kept at a low range and thus CaCl₂ acts as viscosity enhancers in this case. A drop in the observed viscosity is expected if the dosage of encapsulated CaCl₂ is increased.

### Example 3

### Delayed Viscosity Breaker

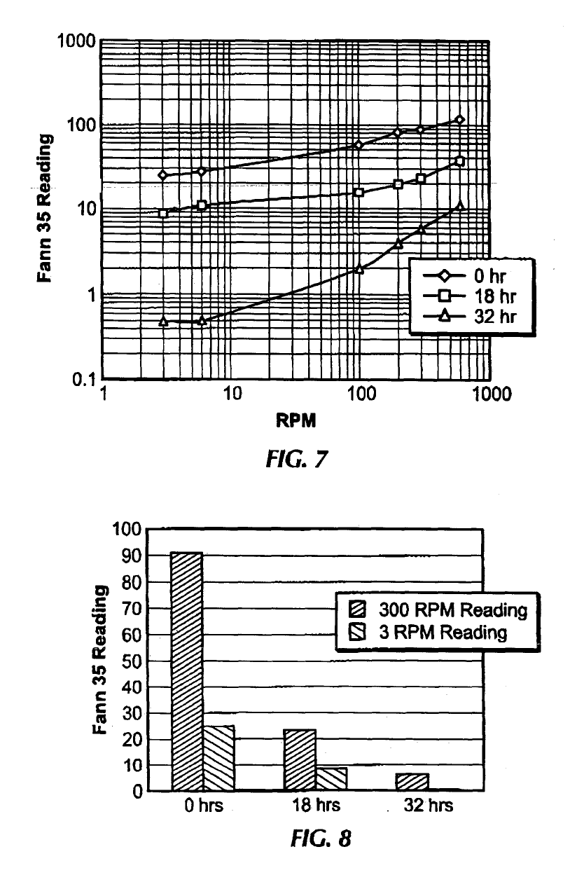

A wellbore fluid formulation containing a delayed breaker was prepared from a sample containing 94% by volume of a 12.5 ppg NaBr brine and 6% vol of VES-C, a C₂₂ betaine surfactant. The sample was then mixed with 4 ppb of encapsulated 70% active CaCl₂ at 120° F. The rheological properties were recorded and measured at 120° F. for 32 hours. With particular reference to FIGS. 7 and 8, a viscosity drop was observed. Specifically, the 300 rpm reading drops from 91 to 24 in 18 hours and to 6 in 32 hours. Accordingly, the 3 rpm reading drops from 25 to 9 in 18 hours and to 0.5 in 32 hours.

### Example 4

### Delayed Viscosity Enhancement

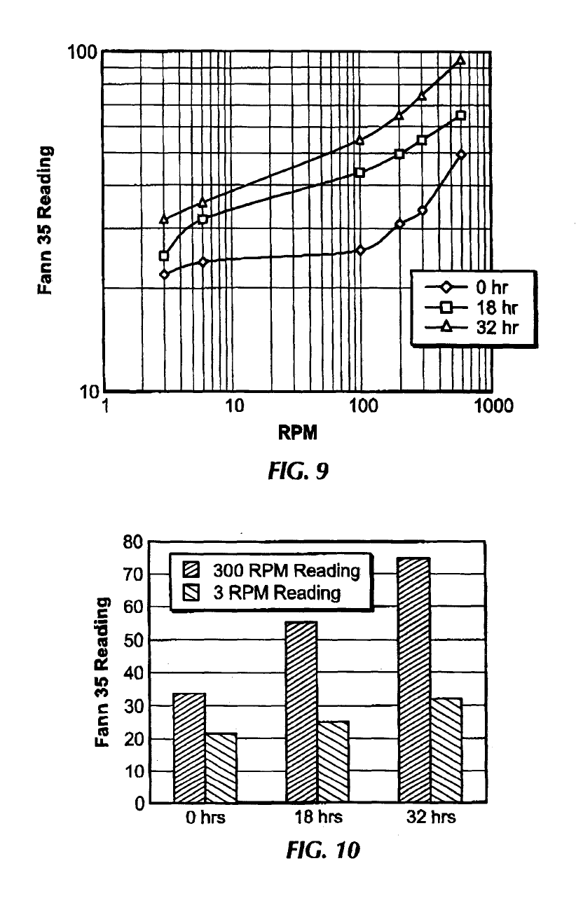

A sample wellbore fluid formulation containing a delayed viscosity enhancer was prepared from a sample containing 92% by volume of a 12.5 ppb NaBr brine and 8% by volume of VES-D, a tallowalkylamidopropyl dimethylamine oxide viscoelastic surfactant. The sample was then mixed with 16 ppb of encapsulated 70% active CaCl₂ salt. The sample was then kept at 120° F. and the rheological profiles were monitored and recorded. With particular reference to FIGS. 9 and 10, a steady increase in viscosity was observed over the 32 hour testing period.

It is also envisioned that, in an embodiment, that adding salts encapsulated by differing chemistries may also be used. For example, a viscosity increase may be induced in a viscoelastic surfactant-containing monovalent brine by the release of polyvalent cations from a polyvalent salt encapsulated in a material which releases the polyvalent salt through passive diffusion, followed by a reduction in viscosity of the viscoelastic surfactant-containing brine from the release of additional polyvalent cations from a polyvalent salt encapsulated by a material having a slower release profile, or a material which releases the salt due to an external stimulus or triggering event such as a pH change, an increase in temperature, enzymatic degradation, the presence of oxidative species or selected solvents, etc. Analogously, in an embodiment, a viscoelastic surfactant-containing polyvalent brine may contain one or more monovalent salts encapsulated in materials that have differing release profiles or encapsulated in materials susceptible to pH change, an increase in temperature, enzymatic degradation, the presence of oxidative species or selected solvents, etc.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A wellbore fluid having controllable viscosity, comprising
a brine comprising a monovalent salt and/or a polyvalent salt;
an encapsulated monovalent salt and/or an encapsulated polyvalent salt; and
a viscoelastic surfactant,
wherein the wellbore fluid contains at least one monovalent salt and at least one polyvalent salt in the form of a brine and/or an encapsulated salt.

2. The wellbore fluid of claim 1, wherein the viscoelastic surfactant is amphoteric or zwitterionic.

3. The wellbore fluid of claim 1, wherein the viscoelastic surfactant is a betaine surfactant.

4. The wellbore fluid of claim 3, wherein the betaine surfactant is oleylamidopropyl betaine surfactant.

5. The wellbore fluid of claim 1, wherein the viscoelastic surfactant is an amidoamine oxide surfactant.

6. The wellbore fluid of claim 5, wherein the amidoamine oxide surfactant is a tallowalkylamidopropyl dimethylamine oxide surfactant

7. The wellbore fluid of claim 1, wherein the release mechanism of the encapsulated monovalent salt and/or the encapsulated polyvalent salt is upon exposure to an external stimulus comprising one or more of heat, pH, enzymatic degradation, or the presence of a solvent capable of solubilizing the encapsulant.

8. The wellbore fluid of claim 1, wherein the encapsulated monovalent salt and/or the encapsulated polyvalent salt comprises one or more encapsulated monovalent salts and/or encapsulated polyvalent salts having different release profiles or release mechanisms.

9. The wellbore fluid of claim 1, wherein the encapsulated monovalent salt and/or the encapsulated polyvalent salt comprises an encapsulant having a layered structure, wherein the layered structure comprises one or more layers of encapsulant having different release profiles or release mechanisms.

10. The wellbore fluid of claim 1, wherein the brine comprises a monovalent salt and a polyvalent salt.

11. The wellbore fluid of claim 1, wherein the total molar ratio of the polyvalent salt to the monovalent salt ranges from 0.1 to 2 percent.

12. The wellbore fluid of claim 1, wherein the total molar ratio of the polyvalent salt to the monovalent salt ranges from 3 to 40 percent.

13. A method for injecting a wellbore fluid having controllable viscosity into a wellbore, comprising:
injecting a wellbore fluid into the wellbore, the wellbore fluid comprising:
a brine comprising a monovalent salt and/or a polyvalent salt,
an encapsulated monovalent salt and/or an encapsulated polyvalent salt, and
at least one viscoelastic surfactant, wherein the wellbore fluid contains at least one monovalent salt and at least one polyvalent salt in the form of a brine and/or an encapsulated salt; and
allowing the encapsulated monovalent salt and/or an encapsulated polyvalent salt to release a percentage of the total available salt from the encapsulated salt, wherein the percent of the total available salt is an amount of salt effective to cause a change in the viscosity of the wellbore fluid.

14. The method of claim 13, wherein the change in viscosity of the wellbore fluid is an increase in viscosity.

15. The method of claim 14, further comprising allowing the encapsulated monovalent salt and/or an encapsulated polyvalent salt to further release the entirety of the total available salt from the encapsulated salt, wherein the entirety of the total available salt is an amount of salt effective to cause a second change in the viscosity of the wellbore fluid.

16. The method of claim 13, wherein the change in viscosity of the wellbore fluid is a decrease in viscosity.

17. The method of claim 13, further comprising allowing the encapsulated salt to further release the entirety of the total available salt from the encapsulated salt, wherein the entirety of the total available salt is an amount of salt effective to cause a second change in the viscosity of the wellbore fluid.

18. The method of claim 13, wherein the wellbore fluid is a fluid loss pill.

19. The method of claim 13, wherein the release mechanism of the encapsulated monovalent salt and/or the encapsulated polyvalent salt is upon exposure to an external stimulus comprising one or more of heat, pH, enzymatic degradation, or the presence of a solvent capable of solubilizing the encapsulant.

20. The method of claim 13, wherein the encapsulated monovalent salt and/or the encapsulated polyvalent salt comprises one or more encapsulated monovalent salts and/or encapsulated polyvalent salts having different release profiles or release mechanisms.

21. The method of claim 13, wherein the encapsulated monovalent salt and/or the encapsulated polyvalent salt comprises an encapsulant having a layered structure, wherein the layered structure comprises one or more layers of encapsulant having different release profiles or release mechanisms.
